(19) United States
(12) Patent Application Publication
(10) Pub. No.: US 2008/0094232 A1
(43) Pub. Date: Apr. 24, 2008

(54) Electronic Apparatus and Method of Controlling the Same

(76) Inventor: Satoshi Yokote, Ome-Shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/845,604

(22) Filed: Aug. 27, 2007

(30) Foreign Application Priority Data
Oct. 24, 2006 (JP) 2006-288869

(51) Int. Cl. G08B 21/00; G06F 1/16

(52) U.S. Cl. 340/604; 361/680

(57) ABSTRACT

According to one embodiment, an electronic apparatus includes a keyboard, a housing, a liquid sensor, a plurality of groove portions, and a water-transmitting material. The housing has a mounting surface on which the keyboard is mounted. A liquid sensor is provided in the mounting surface. The groove portions are formed in the mounting surface, and connect the liquid sensor and a peripheral edge portion of the mounting surface. The water-transmitting material is arranged inside the groove portions and has a spongy internal structure.

### CROSS-REFERENCE TO RELATED APPLICATIONS

This application is based upon and claims the benefit of priority from Japanese Patent Application No. 2006-288869, filed Oct. 24, 2006, the entire contents of which are incorporated herein by reference.

### BACKGROUND

1. Field

One embodiment of the invention relates to an electronic apparatus having a liquid sensor and a method of controlling the same.

2. Description of the Related Art

Jpn. Pat. Appln. KOKAI Pub. No. 2003-122454 discloses a portable computer which prevents liquid from flowing into the housing through the keyboard part. The portable computer comprises a housing having an opening portion, a keyboard covering the opening portion of the housing, a base plate on which keys of the keyboard are arranged, and a first discharge port provided in the base plate. The housing further comprises an edge portion provided around the opening portion, and a groove portion formed in the edge portion. The edge portion serves as a support which supports the keyboard from the back side when the keyboard is mounted on the housing. The groove portion is formed to be connected at one end to the first discharge port of the base plate. The groove portion has, at the other end, a second discharge port connected to the outside of the housing. In the state where the keyboard is mounted on the housing, the bottom surface of the base plate and the groove portion form a channel to discharge liquid.

In such a portable computer, if liquid is spilled over the keyboard, the liquid is discharged from the base plate to the groove portion through the first discharge port. The liquid flows from one end to the other end of the groove portion, and is discharged to the outside of the housing through the second discharge port. Thereby, liquid is prevented from flowing into the housing, by discharging the liquid on the keyboard to the outside of the housing through the groove portion as described above.

However, in the above portable computer of the prior art, the surface tension of liquid acts between the bottom surface of the base plate and the groove portion, and thus the liquid may not smoothly flow through the channel. Therefore, it is possible that the liquid on the base plate is not fully discharged. In such cases, when the user continues to use the portable computer, the liquid may enter the inside of the housing through the opening portion.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment.

FIG. 2 is an exemplary exploded perspective view of the portable computer of FIG. 1, in which a keyboard is disassembled.

FIG. 3 is an exemplary top view of a mounting surface of a housing of the portable computer shown in FIG. 2.

FIG. 4 is an exemplary cross-sectional view taken along line F4-F4 of FIG. 3.

FIG. 5 is an exemplary perspective view of a liquid sensor provided on the mounting surface of FIG. 3.

FIG. 6 is an exemplary exploded perspective view of the portable computer of FIG. 1, illustrating electrical connection between the liquid sensor, a printed circuit board, and a display.

FIG. 7 is an exemplary block diagram illustrating an example of a system configuration of the portable computer shown in FIG. 1.

FIG. 8 is an exemplary perspective view of a portable computer according to a second embodiment.

FIG. 9 is an exemplary cross-sectional view taken along line F9-F9 of FIG. 8.

FIG. 10 is an exemplary cross-sectional view of a portable computer according to a third embodiment.

FIG. 11 is an exemplary cross-sectional view of a portable computer according to a fourth embodiment.

### DETAILED DESCRIPTION

Various embodiments according to the invention will be described hereinafter with reference to the accompanying drawings. In general, according to one embodiment of the invention, an electronic apparatus includes a keyboard, a housing, a liquid sensor, a plurality of groove portions, and a water-transmitting material. The housing has a mounting surface on which the keyboard is mounted. A liquid sensor is provided in the mounting surface. The groove portions are formed in the mounting surface, and connect the liquid sensor and a peripheral edge portion of the mounting surface. The water-transmitting material is arranged inside the groove portions and has a spongy internal structure.

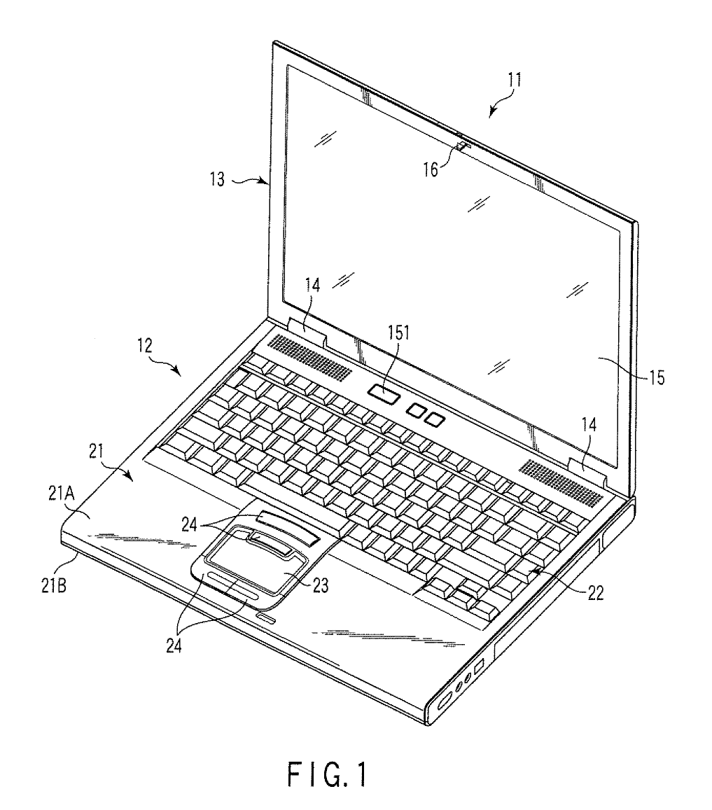

A first embodiment of an electronic apparatus according to the present invention is described with reference to FIGS. 1 to 7. As shown in FIG. 1, a portable computer 11, as an example of the electronic apparatus, comprises a main unit 12, a display unit 13, and a hinge part 14 provided between the main unit 12 and the display unit 13. The hinge part 14 supports the display unit 13, and enables the display unit 13 to rotate with respect to the main unit 12. The display unit 13 has a liquid crystal display (LCD) 15, and a latch 16. The liquid crystal display 15 is an example of an informing mechanism.

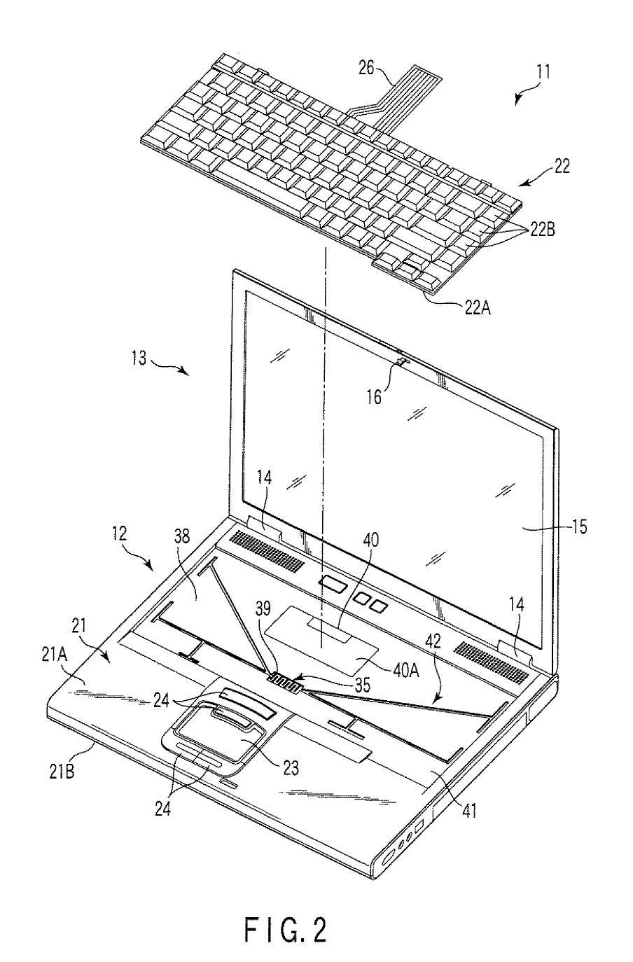

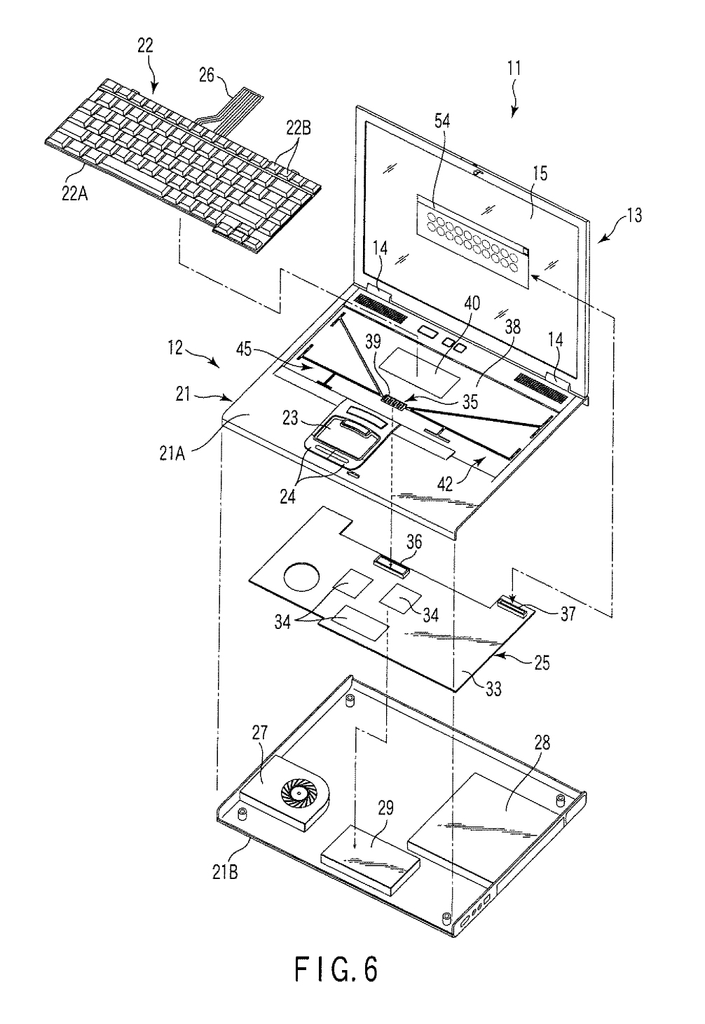

As shown in FIGS. 2 and 6, the main unit 12 comprises a housing 21, a keyboard 22, a touch pad 23 and a button 24, which serve as pointing devices, a printed circuit board 25 which is a control unit contained in the housing 21, a wire 26 which connects the keyboard 22 and the printed circuit board 25, a fan unit 27, an optical disk drive 28, and a hard disk drive 29. Software, that is, a program, is installed in the hard disk drive 29. The software displays a message when liquid is sensed. The hard disk drive 29 is electrically connected to the printed circuit board 25 to exchange data with the printed circuit board 25. The keyboard 22 has a base plate 22A, and a plurality of keys 22B arranged on the upper side of the base plate 22A. Further, as shown in FIG. 6, the liquid crystal display 15 is electrically connected to the printed circuit board 25.

The printed circuit board 25 is an example of a control unit. As shown in FIG. 6, the printed circuit board 25 has a board main body 33, a plurality of electronic parts 34 mounted on the board main body 33, a first connector 36 for connection with a liquid sensor 35 explained below, and a second connector 37 for connection with the liquid crystal display 15. The electronic parts 34 include, for example, a CPU (central processing unit), a ROM (Read Only Memory), a RAM (Random Access Memory), and a graphics chip and the like.

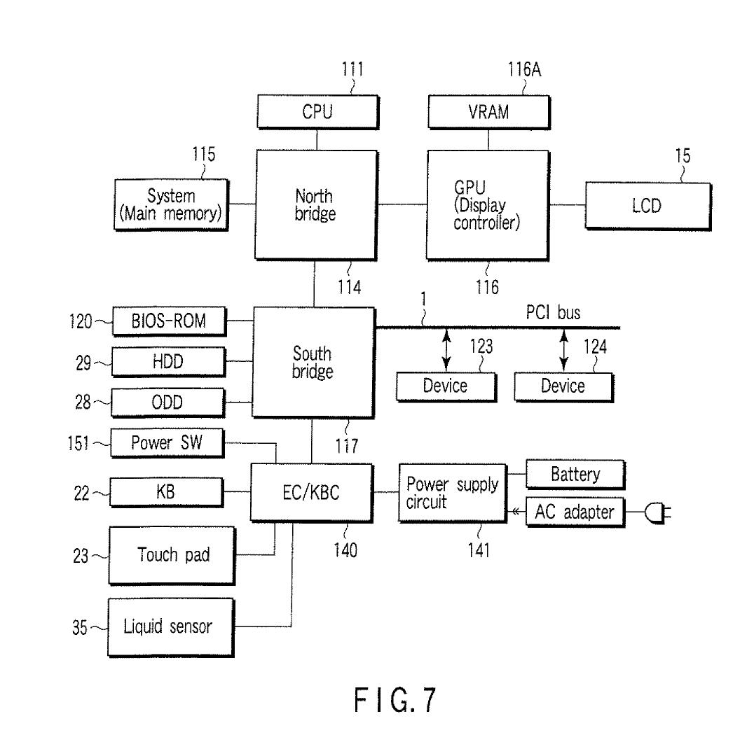

A system configuration of the portable computer 11 is specifically explained with reference to FIG. 7.

As shown in FIG. 71 the portable computer 11 has a CPU 111, a north bridge 114, a system memory (which is also referred to as “main memory”) 115, a graphics processing unit (GPU) 116, a south bridge 117, a BIOS-ROM 120, the hard disk drive (HDD) 29, the optical disk drive 28, PCI devices 123 and 124, an embedded controller/keyboard controller IC (EC/KBC) 140, and a power supply circuit 141.

The CPU 111 is a processor that controls the operation of the portable computer 11, and executes the operating system and various programs which are loaded from the HOD 29 to the system memory 115.

The CPU 111 also executes a BIOS (Basic Input Output System) stored in the BIOS-ROM 120. BIOS is a program for hardware control.

The north bridge 114 is a bridge device which connects a local bus of the CPU 111 with the south bridge 117. The north bridge 114 stores a memory controller which controls access to the main memory 115. Further, the north bridge 114 has a function of executing communications with the graphics processing unit (GPU) 116 through a PCI Express bus.

The graphics processing unit (GPU) 116 is a display controller which controls the LCD 15 used as a display monitor of the portable computer 11. The GPU 116 generates an image signal which forms a screen image to be displayed on the LCD 15, from display data written in a video memory (VRAM) 116A by the OS or an application program. Further, the CPU 116 also has a drawing function of executing two-dimensional or three-dimensional graphics operation processing in accordance with a drawing request from the OS or an application program.

The south bridge 117 is connected to a PCI bus 1, and executes communications with the PCI devices 123 and 124 through the PCI bus 1. Further, the south bridge 117 includes an IDE (Integrated Drive Electronics) controller and a Serial ATA controller for controlling the hard disk drive (HDD) 29 and the optical disk drive (ODD) 28.

The embedded controller/keyboard controller IC (EC/KBC) 140 is a one-chip micro computer formed by integrating an embedded controller for electric power control with a keyboard controller for controlling the touch pad 23 and the liquid sensor 35. The EC/KBC 140 is always supplied with operating power from the power supply circuit 141, even when the power of the portable computer 11 is turned off.

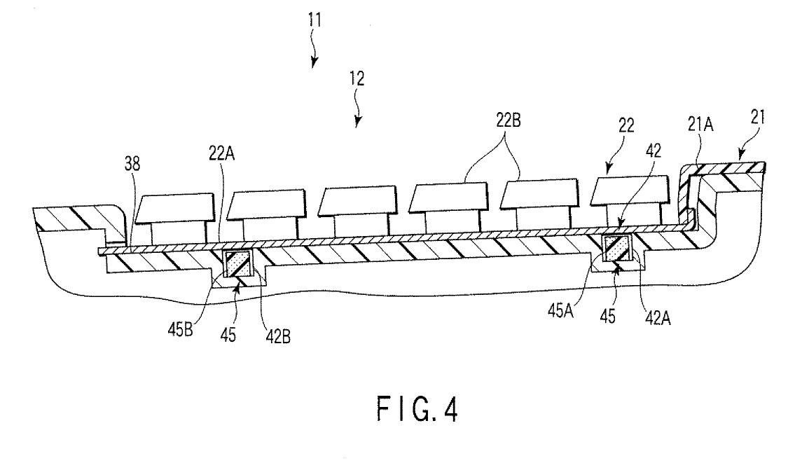

Next, the structure of the housing 21 is explained in detail. As shown in FIG. 2, the housing 21 has a first case 21A serving as an upper lid, and a second case 21B serving as a lower lid. The first case 21A of the housing 21 has a mounting surface 38 on which the keyboard 22 is mounted, a recessed portion 39 provided in the mounting surface 38, an opening portion 40 formed in the mounting surface 38, a peripheral edge portion 41 provided in the mounting surface 38, and a plurality of groove portions 42 formed in the mounting surface 38. The mounting surface 38 is lower than the other portions of the housing 21 by one step to have a flat recessed shape. In the first embodiment, as shown in FIG. 4, the mounting surface 38 is inclined to be gradually lowered toward the front of the portable computer 11. The recessed portion 39 has a square shape, and is further lower than the mounting surface 38 by one step. A liquid sensor 35, which is an example of a liquid sensing mechanism, is disposed in the recessed portion 39. The wire 26 runs through the opening portion 40. A protective plate 40A is fitted into the opening portion 40 to cover and protect this part.

The groove portions 42 is formed in the mounting surface 38 to connect the recessed portion 39, provided with the liquid sensor 35, to the peripheral edge portion 41. The groove portions 42 radially spread, with the recessed portion 39 serving as the center. The groove portions 42 are formed in areas not including the opening portion 40.

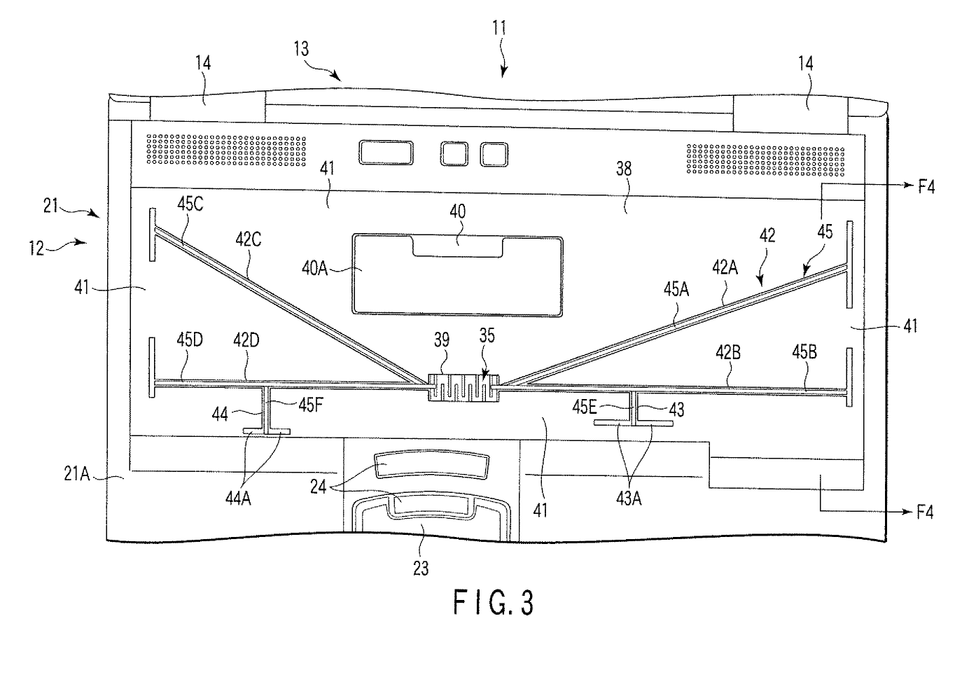

More specifically, as shown in FIG. 3, the groove portions 42 includes a first groove portion 42A which extends from the recessed portion 39 toward the back right direction of the drawing, a second groove portion 42B which extends from the recessed portion 39 toward the right direction of the drawing, a third groove portion 42C which extends from the recessed portion 39 toward the back left direction of the drawing, and a fourth groove portion 42D which extends from the recessed portion 39 toward the left direction of the drawing. Each of the first to fourth groove portions 42A to 42D is branched, for example, into two in the peripheral edge portion 41 of the mounting surface 38. The second groove portion 425 has a first auxiliary groove portion 43 which branches off from an intermediate point of the second groove portion 42B toward the front direction of the drawing. The first auxiliary groove portion 43 has a first branch portion 43A which further branches off in two directions in the peripheral edge portion 41 of the mounting surface 38. The fourth groove portion 42D has a second auxiliary groove portion 44 which branches off from an intermediate point of the fourth groove portion 42D toward the front direction of the drawing. The second auxiliary groove portion 44 has a second branch portion 44A which further branches off into two directions in the peripheral edge portion 41 of the mounting surface 38.

A plurality of non-woven materials 45 are arranged inside the respective groove portions 42. Specifically, a first hydrophilic non-woven material 45A is disposed inside the first groove portion 42A. A second hydrophilic non-woven material 45B is disposed inside the second groove portion 42B. A third hydrophilic non-woven material 45C is disposed inside the third groove portion 42C. A fourth hydrophilic non-woven material 45D is disposed inside the fourth groove portion 42D. A fifth hydrophilic non-woven material 45E is disposed inside the first auxiliary groove portion 43. A sixth hydrophilic non-woven material 45F is disposed inside the second groove portion 44.

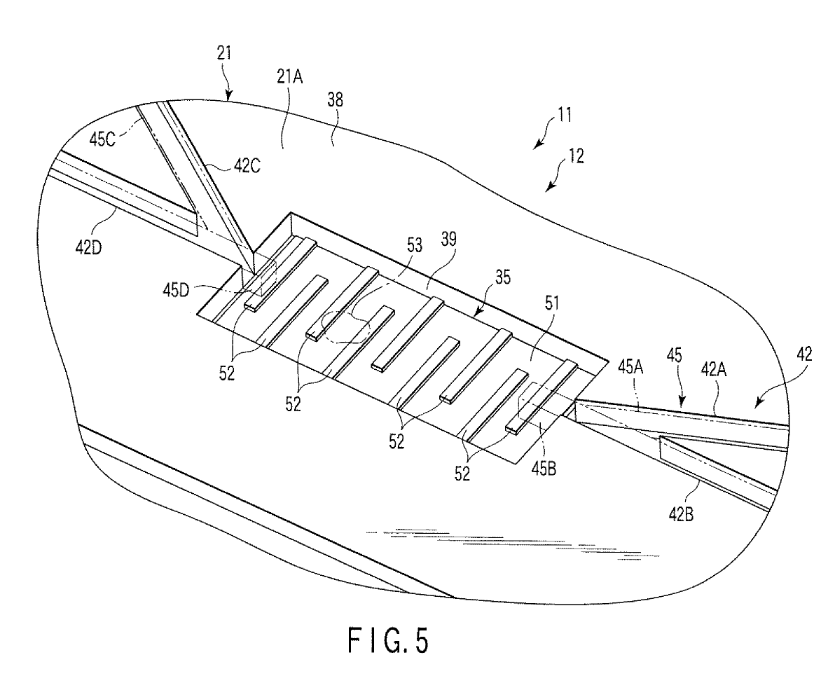

The non-woven materials 45A to 45F are an example of a water-transmitting bar material having a spongy internal structure, that is, a water-transmitting material. The non-woven materials 45A to 45F have a porous structure due to the spongy internal structure thereof, and thus can cause the capillary phenomenon. By the capillary phenomenon, liquid inside the non-woven materials 45A to 45F is guided to desired directions. For example, the fifth and the sixth non-woven materials 45E and 45F shown in FIG. 3 can absorb liquid collected in the front position of the mounting surface 38 in a direction against gravity, such that the liquid sensor 35 can sense it. Further, the non-woven materials 45A to 45F are porous, and thus also have water absorbency and water-retaining property. The non-woven materials 45A to 45F have a bar shape with a square cross section to be fitted into the groove portions 42, as shown in FIGS. 3 and 4. As shown in FIG. 5, the second and the fourth non-woven materials 45B and 45D, which are water-transmitting materials, are provided inside the groove portions 42 and project over the liquid sensor 35.

As shown in FIG. 5, the liquid sensor 35 has a substrate 51, and a plurality of electrodes 52 provided on the substrate 51. The electrodes S2 are arranged in parallel with intervals therebetween. As shown in FIG. 6, the liquid sensor 35 is electrically connected to the printed circuit board 25.

Next, explained is an operation when liquid is spilled over the portable computer 11 of the first embodiment, and a controlling method thereof. When liquid is spilled over the keyboard 22, part of the liquid reaches the mounting surface 38 of the housing 21 from the upper side of the base plate 22A of the keyboard 22. Further, in the peripheral edge portion 41 of the mounting surface 38, the liquid flows into the groove portions 42. The liquid is absorbed by the non-woven materials 45A to 45F, and guided to the liquid sensor 35. As shown in FIG. 5, in the liquid sensor 35, when the liquid spreads over two adjacent electrodes 52 and forms a liquid drop S3, the two electrodes 52 become electrically conducted. Thereby, the liquid sensor 35 senses the liquid. The liquid sensor 35 transmits a detection signal notifying that liquid is detected to the printed circuit board 25.

In detection of liquid, more specifically, the embedded controller/keyboard controller IC 140 transmits an interrupt signal to the CPU 111. The software, that is, the CPU 111 detects presence of liquid in the liquid sensor 35, with the interrupt signal used as a trigger. Based on this detection, the CPU 111 executes processing to output a detection result to the liquid crystal display 15, the informing mechanism. Thereby, the liquid crystal display 15 can visually inform the user of detection of liquid.

As shown in FIG. 6, a detection result message 54 such as “Liquid is detected in the computer. Shut down the computer immediately and take this computer to the repair center.” is displayed on the liquid crystal display 15.

According to the first embodiment of the electronic apparatus, the mounting surface 38 of the keyboard 22 is provided with the liquid sensor 35 and the groove portions 42, and liquid is guided to the liquid sensor 35 through the groove portion 42. Thereby, it is possible to monitor the whole mounting surface 38 with a small number of liquid sensors 35.

Further, the non-woven materials 45A to 45F, which are water-transmitting bar materials having a spongy material inside, are arranged in the groove portions 42. Therefore, even when liquid flows onto the mounting surface 38, the liquid is absorbed into the non-woven materials 45A to 45F. Thereby, the liquid is maintained inside the non-woven materials 45A to 45F, and prevented from leaking to other parts of the housing 21. Further, the non-woven materials 45A to 45F rapidly guide the liquid to the liquid sensor 35, and shorten the time required for detection of the liquid. Furthermore, since liquid is conveyed to the liquid sensor 35 through the non-woven materials 45A to 45F, even a small amount of liquid can be reliably detected.

Further, in the case where the mounting surface 38 is inclined, liquid is collected by gravitation in the front part of the mounting surface 38 which is lower. In this case, the fifth non-woven material 45E can absorb liquid inside the first auxiliary groove portion 43 up to the liquid sensor 35 in the higher position. In the same manner, the sixth non-woven material 45F can absorb liquid inside the second auxiliary liquid 44 up to the liquid sensor 35 in the higher position. This allows more flexible placement of the liquid sensor 35.

The non-woven materials 45A to 45F, which are water-transmitting materials, are provided inside the groove portions 42 and project over the liquid sensor 35. According to this structure, liquid held in the groove portion 42 is reliably conveyed to the liquid sensor 35. Therefore, liquid is sensed with more accuracy by the liquid sensor 35.

The groove portions 42 radially extend, with the recessed portion 39, in which the liquid sensor 35 is provided, serving as the center. According to this structure, liquid in the peripheral edge portion 41 of the mounting surface 38 is smoothly flown into the groove portions 42, and is prevented from remaining in the peripheral edge portion 41 of the mounting surface 38.

The groove portions 42 are branched to have a T shape in the peripheral edge portion 41 of the mounting surface 38. According to this structure, liquid is more efficiently collected into the groove portions 42 in the peripheral edge portion 41 of the mounting surface 38.

The groove portions 42 are arranged in areas apart from the opening portion 40 formed in the mounting surface 38. This structure prevents liquid from approaching the vicinity of the opening portion 40 where the keyboard 22 and the printed circuit board 25 are electrically connected.

The printed circuit board 25 operates the liquid crystal display 15, which is an informing mechanism, on the basis of a signal from the liquid sensor 35, and informs the user of entrance of liquid into the computer. According to this structure, since the user is immediately notified of entrance of liquid into the computer, an increase in damage due to water soaking while the computer is still in use is prevented.

Further, the portable computer 11, which is an example of the electronic apparatus, has the liquid sensor 35, and the printed circuit board 25 serving as a control unit which outputs a notification (signal) informing detection of liquid when the liquid sensor 35 senses a liquid. According to this structure, when the liquid sensor 35 detects liquid, the printed circuit board 25 can immediately output a signal informing detection of liquid. The destination of a detection signal output from the printed circuit board 25 may be the liquid crystal display 15, or external apparatuses.

The portable computer 11 further has the groove portions 42 formed in the mounting surface 38 to connect the liquid sensor 35 to the peripheral edge portion 41 of the mounting surface 38, and non-woven materials 45 arranged inside the groove portions 42 which are water-transmitting materials having a spongy material inside. According to this structure, liquid is guided to the liquid sensor 35 by the groove portions 42 and the non-woven materials 45, and thus liquid detection performance and detection speed are improved. Therefore, the whole mounting surface 38 can be monitored with the liquid sensor 35, and a notification informing detection of liquid is rapidly output.

In a method of controlling the portable computer 11, which is an example of the electronic apparatus, when liquid is sensed by the liquid sensor 35, processing of outputting a notification of detection of liquid is performed. According to this structure, a notification informing detection of liquid is output, and thus the user is rapidly notified that there is the possibility that the computer is soaked by the liquid.

In this case, the processing is outputting a visual message. According to the structure, it is possible to notify the user most directly of the possibility that the computer is soaked by the liquid.

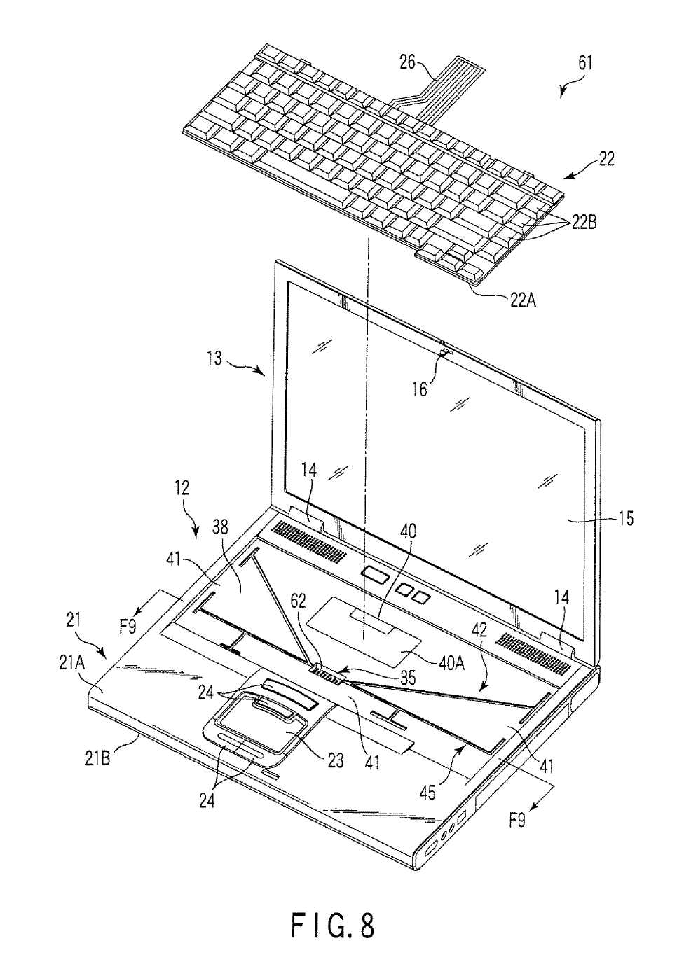

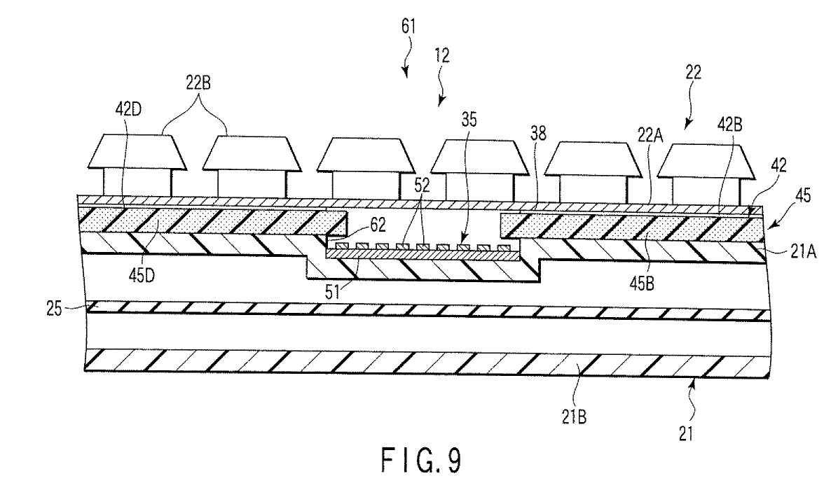

A second embodiment of the present invention is next described with reference to FIGS. 8 and 9. A portable computer 61 as an example of an electronic apparatus according to the second embodiment has the same constituent elements as that in the first embodiment, except for the structure of recessed portion 62, in which a liquid sensor 35 is mounted. Therefore, constituent elements of the second embodiment which are different from the structure of the first embodiment are mainly explained, and constituent elements which are the same as those in the first embodiment are denoted by the same respective reference numerals and not explained in the second embodiment.

The portable computer 61 has a main unit 12, a display unit 13, and a hinge part 14. The main unit 12 has a housing 21 and a keyboard 22. A printed circuit board 25 is contained in the housing 21. The housing 21 has a mounting surface 38 on which the keyboard 22 is mounted, a recessed portion 62 provided in the mounting surface 38, and a plurality of groove portions 42 extending from the recessed portion 62 to a peripheral edge portion 41 of the mounting surface 38. A plurality of non-woven materials 45, which are water-transmitting materials having a spongy material inside, are arranged in the respective groove portions 42. The liquid sensor 35 is mounted in the recessed portion 62.

As shown in FIGS. 8 and 9, the recessed portion 62 has a square shape, and is lower by one step than the mounting surface 38 and the groove portions 42. Specifically, the recessed portion 62 of the mounting surface 38 according to the second embodiment is formed deeper than the recessed portion 39 of the first embodiment.

An operation of the portable computer 61 of the second embodiment is next explained. In the portable computer 61, liquid reaching the peripheral edge portion 41 of the mounting surface 38 flows into the groove portions 42. In the groove portions 42, the liquid is absorbed into the non-woven materials 45. The liquid absorbed into the non-woven materials 45 is supplied to the recessed portion 62 through the inside of the non-woven materials 45. Further, when the state non-woven materials 45 is such that no more liquid can be taken into the non-woven materials 45, that is, when the non-woven materials 45 are saturated, overflow liquid is collected in the recessed portion 62.

According to the second embodiment, liquid reaching the mounting surface 38 of the housing 21 is detected by the liquid sensor 35. Further, even when a large amount of liquid is spilled over the keyboard 22 and liquid of an amount exceeding the capacity of the non-woven materials 45 flows inside through the keyboard 22, the excess liquid is collected into the recessed portion 62. This structure prevents liquid exceeding the capacity of the non-woven materials 45 from spreading over the mounting surface 38 and entering the housing 21.

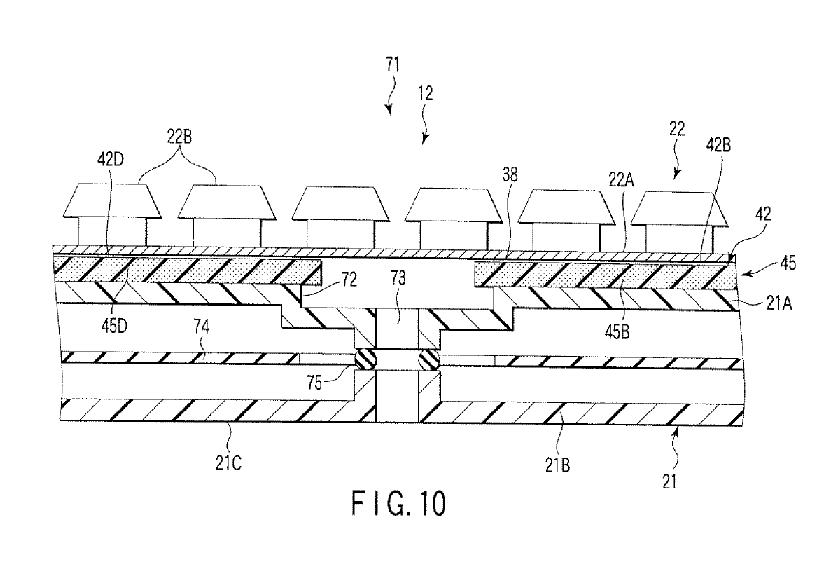

Next, a third embodiment of the electronic apparatus is explained with reference to FIG. 10. A portable computer 71, as an example of an electronic apparatus according to the third embodiment, differs from the second embodiment as regards a recessed portion 72 of a mounting surface 38 and the absence of a liquid sensor 35. Therefore, constituent elements which are different from those of the second embodiment are mainly explained, and the same constituent elements as those of the second embodiment are denoted by the same respective reference numerals and are not explained.

The portable computer 71 of the third embodiment has a main unit 12, a display unit 13, and a hinge part 14. The main unit 12 has a housing 21 and a keyboard 22. The housing 21 has a first case 21A serving as an upper lid, and a second case 21B serving as a lower lid. The first case 21A of the housing 21 has a mounting surface 38 on which the keyboard 22 is mounted, a recessed portion 72 provided in the mounting surface 38, and a plurality of groove portions 42 extending from the recessed portion 72 to a peripheral edge portion of the mounting surface 38. A plurality of non-woven materials 45, which are water-transmitting materials having a spongy material inside, are arranged in the respective groove portions 42.

According to the third embodiment, no liquid sensor is provided in the recessed portion 72, and a drain channel 73 is formed in a part of the housing 21 instead. The drain channel 73 is connected at one end to the recessed portion 72, and connected at the other end to a bottom surface 21C of the housing 21. Further, in the part forming the drain channel 73, a seal member 75 formed of rubber or the like is provided in a junction part of the first case 21A and the second case 21B of the housing 21. Further, a printed circuit board 74 is contained in the housing 21, avoiding the part having the drain channel 73.

An operation of the portable computer 71 according to the third embodiment is explained next. In the portable computer 71, liquid reaching the peripheral edge portion of the mounting surface 38 through the keyboard 22 flows into the groove portions 42, and is absorbed by the non-woven materials 45. When liquid of an amount exceeding the capacity of the non-woven materials 45 flows into the groove portions 42, the excess liquid is discharged from the non-woven materials 45 into the recessed portion 72. In the recessed portion 72, the liquid flows into the drain channel 73, and is discharged to the outside of the housing 21.

According to the third embodiment, liquid spilled over the keyboard 22 is absorbed by the non-woven materials 45 in the groove portions 42, and prevented from entering the inside of the housing 21. Further, even when a liquid of an amount exceeding the capacity of the non-woven materials 45 is spilled over the keyboard 22, the excess liquid is collected into the recessed portion 72, and discharged to the outside of the housing 21 through the drain channel 73.

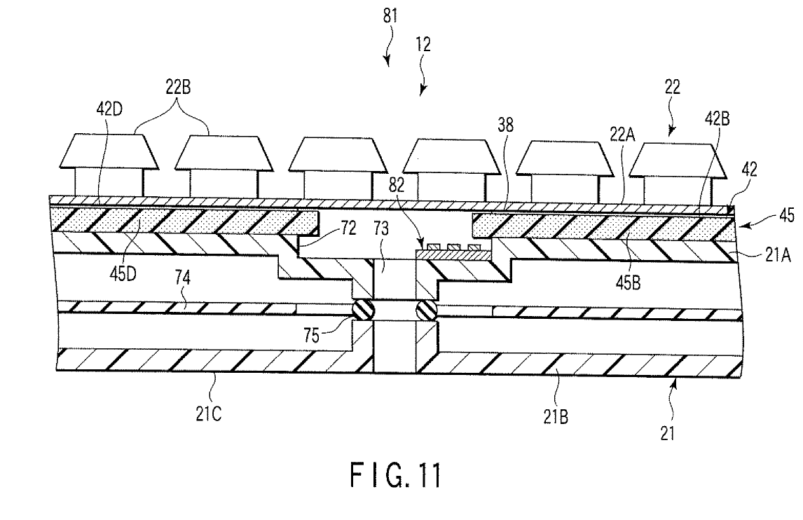

Next, a fourth embodiment of the electronic apparatus is explained with reference to FIG. 11. A portable computer 81 as an example of the electronic apparatus according to the fourth embodiment differs from the third embodiment as regards addition a liquid sensor 82. Therefore, constituent elements which are different from those of the third embodiment are mainly explained, and the same constituent elements as those of the third embodiment are denoted by the same respective reference numerals and are not explained.

The portable computer 81 of the fourth embodiment has a main unit 12, and a display unit. The main unit 12 has a housing 21 and a keyboard 22. The housing 21 has a first case 21A serving as an upper lid, and a second case 21B serving as a lower lid. The first case 21A of the housing 21 has a mounting surface 38 on which the keyboard 22 is mounted, a recessed portion 72, a plurality of groove portions 42 extending from the recessed portion 72 to a peripheral edge portion of the mounting surface 38, a drain channel 73 connected to the recessed portion 72, and a seal member 75 provided in a midpoint of the drain channel 73. A liquid sensor 82 is provided in the recessed portion 72.

An operation of the portable computer 81 according to the fourth embodiment is next explained. In the portable computer 81, when liquid is spilled over the keyboard 22, the liquid flows into the groove portions 42 from a peripheral edge portion of the mounting surface 38. The liquid is absorbed by the non-woven materials 45 in the groove portions 42. The liquid absorbed by the non-woven materials 45 is conveyed to the recessed portion 72 through the inside of the non-woven materials 45. The liquid supplied to the recessed portion 72 is detected by the liquid sensor 82. Then, a printed circuit board 74 informs the user that liquid is detected in the computer through a liquid crystal display. Even when liquid of an amount exceeding the capacity of the non-woven materials 45 is spilled over the keyboard 22, the liquid is discharged to the outside of the housing 21 through the drain channel 73.

According to the fourth embodiment, when liquid is spilled over the keyboard 22, the liquid sensor 82 detects the liquid. Further, even when liquid of an amount exceeding the capacity of the non-woven materials 45 is spilled over the keyboard 22, the excess liquid is discharged to the outside of the housing 21 through the drain channel 73.

The electronic apparatus of the present invention is not limited to portable computers. The present invention is also applicable to other electronic apparatuses, such as mobile information terminals. Further, the number of liquid sensors 35 or 82 is not limited to one. A plurality of liquid sensors may be formed in the mounting surface 38.

If the liquid sensor 35 or 82 cannot be disposed in the position described in the above embodiments in view of a positional relationship with the printed circuit board 25 or 74 and the opening portion 40, the liquid sensor may be disposed in a part of the mounting surface 38 closer to the rear of the portable computer 11. In the above embodiments, the liquid sensor 35 is disposed higher than the front part of the mounting surface 38 where liquid is collected. Even in such cases, the non-woven materials 45 can absorb liquid flowing into the groove portions 42 in a direction against gravity by virtue of the capillary action thereof. Therefore, the liquid sensor 35 can be disposed in a desired position in the mounting surface 38.

Further, as shown in FIG. 5, although the second non-woven material 45B and the fourth non-woven material 45D are provided inside the groove portions 42 and project over the liquid sensor 35, the second and fourth non-woven materials 45B and 45D may be integrated into one non-woven material, and the one integrated non-woven material may be provided. In this case, the one non-woven material passes over the liquid sensor 35, and thereby the sensitivity for liquid detection is increased.

The informing mechanism is not limited to the liquid crystal display 15. For example, a speaker may be provided on the printed circuit board 25 to acoustically inform the user by an audible alarm. Further, as another example of the informing mechanism which visually informs the user of liquid detection, an alarm lamp such as a light-emitting diode may be used. According to this structure, an alarm lamp is turned on to visually inform the user of entrance of liquid into the computer. Further, the arrangement of the non-woven materials 45 is not limited to one in the above embodiments. It suffices that non-woven material 45 is provided in at least part of the groove portions 42.

Although the above embodiments show examples where the mounting surface 38 of the housing 21 is slightly inclined toward the front, the present invention is not limited to such. The present invention is also applicable to structures where the mounting surface 38 is horizontal. Further, the present invention is also applicable to portable computers having leg portions in the bottom surface 21C of the housing 21. In the structures with leg portions, the mounting surface 38 of the portable computer may be disposed at various angles. In such cases, the arrangement of the non-woven materials 45 may be variously changed to control liquid flow. Further, the electronic apparatus may be variously modified within a range not diverting from the gist of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a keyboard;
a housing having a mounting surface on which the keyboard is mounted;
a liquid sensor provided on the mounting surface;
a plurality of groove portions formed in the mounting surface and connecting the liquid sensor with a peripheral edge portion of the mounting surface; and
a water-transmitting material arranged inside the groove portions and having a spongy internal structure.

2. An electronic apparatus according to claim 1, wherein
the water-transmitting material is provided inside the groove portions and over the liquid sensor.

3. An electronic apparatus according to claim 1, wherein
the groove portions radially extend, with the liquid sensor serving as a center.

4. An electronic apparatus according to claim 3, wherein
each of the groove portions is branched in the peripheral edge portion.

5. An electronic apparatus according to claim 3, further comprising:
a printed circuit board processing a signal transmitted from the liquid sensor; and
a wire connecting the keyboard and the printed circuit board,
wherein the groove portions are arranged in positions apart from an opening portion, which is provided in the mounting surface and through which the wire runs.

6. An electronic apparatus according to claim 5, further comprising:
an informing mechanism which is electrically connected to the printed circuit board,
wherein the printed circuit board informs the user of a detection result, by operating the informing mechanism based on the signal from the liquid sensor.

7. An electronic apparatus comprising:
a keyboard;
a housing having a mounting surface on which the keyboard is mounted;
a liquid sensor provided on the mounting surface; and
a control unit which outputs a notification of liquid detection, when liquid is detected by the liquid sensor.

8. An electronic apparatus according to claim 7, further comprising:
a plurality of groove portions formed in the mounting surface and connecting the liquid sensor with a peripheral edge portion of the mounting surface; and
a water-transmitting material arranged inside the groove portions and having a spongy internal structure.

9. A method of controlling an electronic apparatus, the electronic apparatus including:
a keyboard;
a housing having a mounting surface on which the keyboard is mounted; and
a liquid sensor provided on the mounting surface, the method comprising:
performing processing of outputting a notification of liquid detection when the liquid sensor detects liquid.

10. A method according to claim 9, wherein
the processing is outputting a visual notification.
